(19) United States
(12) Patent Application Publication
(10) Pub. No.: US 2003/0149904 A1
(43) Pub. Date: Aug. 7, 2003

(54) Power management method for portable electronic terminals

(75) Inventor: Ju-Hun Kim, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/299,404

(22) Filed: Nov. 19, 2002

(30) Foreign Application Priority Data
Feb. 4, 2002 (KR) 2002-6204

(51) Int. Cl. G06F 1/26

(52) U.S. Cl. 713/330

(57) ABSTRACT

Disclosed is a power management method for portable electronic terminals. According to the present invention, a priority rank is decided in accordance with the user's intention, or on the degree of importance of each functional module, or on the operation time thereof. Therefore, when power is deficient, the modules with lower priorities are not provided with power temporarily, but operation of the modules with higher priorities is guaranteed.

### PRIORITY

This application claims priority to an application entitled “Power Management Method For Portable Electronic Terminals” filed in the Korean Industrial Property Office on Feb. 4, 2002 and assigned Serial No. 2002-0006204, the contents of which are incorporated herein by reference.

### BACKGROUND OF THE INVENTION

1. Field of the Invention

The present invention relates generally to portable electronic terminals, and more particularly, to a power management method for portable electronic terminals.

2. Description of the Related Art

In general, the term portable electronic terminal means an electronic terminal like a computer, a scanner, or a mobile communication station that is hand-held and portable. Typical examples of the portable electronic terminal include cellular phones, notebook computers, PDA (Personal Digital Assistant), and digital cameras. The portable electronic terminals are gradually becoming more sophisticated and diversified. In fact, a compound terminal with more than two functions is under development, and an electronic terminal that is connectable to external equipment is already available to users. For example, there are portable phones with a built-in GPS (Global Positioning System), PDA with phone function, digital cameras with a built-in Moving Picture Experts Group (MPEG) player 3, or portable phones with digital camera capabilities.

Normally, the power source of the portable electronic terminal is a re-chargeable battery that is usually mounted on the terminal. The available power for operating the portable electronic terminal is limited, depending on the capacity of the battery, and therefore, total usage time a user can use the device is also limited. As an attempt to solve these problems, a more effective method for managing power to drive the portable electronic terminals for an extended period of time with a limited power source have been contemplated. The problems are magnified especially for the compound terminal because an auxiliary module often consumes more power than a main module. The main module is used for performing major functions of the compound terminal. For example, in a PDA phone with a built-in phone function, the main module is in charge of performing PDA function. The auxiliary module can be built in additionally, or it can be mounted on the outside. Primarily, the auxiliary module performs auxiliary functions, such as, the phone function in the PDA phone. Many times however, the auxiliary modules consume much more power than the main modules. In an extreme case, the main module will not even work because all power is required by the auxiliary module. That is, the module with phone function in the PDA phone consumes more power than the module with PDA function, and as a result thereof, the least power necessary to drive the module with PDA function is consumed for operating the module with phone function.

### SUMMARY OF THE INVENTION

It is, therefore, an object of the present invention to provide a power management method for portable electronic terminals, capable of distributing power more effectively.

Another object of the present invention is to provide a power management method for portable electronic terminals, capable of saving power.

To achieve the above objects, there is provided a power management method for a portable electronic terminal having a plurality of modules that are distinguished in accordance with specific functions of the terminals in order to perform necessary operations for every kind of function, wherein the method includes the steps of: determining a priority rank of permitted power for each module according to a user's choice; determining a sum of necessary power to turn on the plural modules under power-saving mode, and measuring currently available power at intervals of a predetermined cycle; comparing the sum of necessary power to turn on the modules to the currently available power; and if the currently available power is less than the sum of necessary power to turn on the modules, permitting the currently available power to at least one operational module in accordance with a pre-designated priority rank of the permitted power given to each module.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram of a portable electronic terminal to which the resent invention is applied;

FIG. 2 is a battery's self-power consumption curve in accordance with a preferred embodiment of the present invention;

FIG. 3a is an operational flow chart of the basic power saving procedure in accordance with the preferred embodiment of the present invention;

FIG. 3b is an operational flow chart of a cyclic operational procedure of a module in accordance with the preferred embodiment of the present invention; and

FIG. 3c is an operational flow chart of the controller at an external request in accordance with the preferred embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Primarily, the present invention is devised to more effectively manage power of the portable electronic terminal. A priority is assigned given to each module, depending on the intension of a user, on the degree of importance of each module, or on the operation time thereof. Therefore, when power is deficient, a module with the lowest priority is the first one to which the power supply is discontinued, and the discontinuing of power proceeds in ascending order, meaning modules with higher priorities are guaranteed for continuous operation.

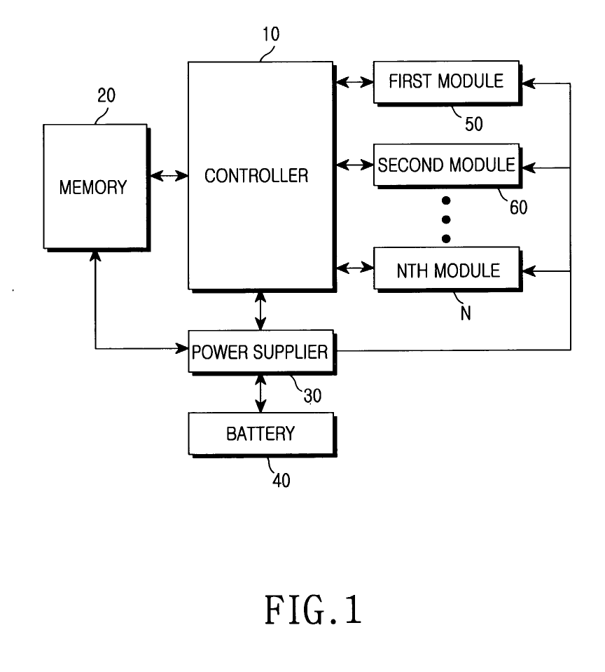

The structure of a portable electronic terminal to which the present invention is applied is first explained with reference to FIG. 1. In other words, FIG. 1 is a schematic diagram of a portable electronic terminal embodying the principles of the present invention. As shown in the drawing, the portable electronic terminal includes a controller 10, a memory 20, a power supplier 30, a battery 40, and a plurality of modules (50, 60, . . . , N). The controller 10 controls general operation of the portable electronic terminal, and in the present invention, it controls power management. The battery 40 is a re-chargeable battery, and outputs a fixed amount of current and voltage to the power supplier 30. The power supplier 30, under the control of the controller 10, adjusts the amount of the current or voltage that is inputted from the battery 40, and provides power to the controller 10, the memory 30 and the modules 50, . . . , N.

The plural modules 50, . . . , N are distinguished in accordance with a specific function of the portable electronic terminal, and they perform necessary operations in conformity with each function. In case where the portable electronic terminal is a cellular phone, the modules are divided for example into a LCD (Liquid Crystal Display) operating module, a radio transmission/receipt operating module, a backlight operating module, a microphone operating module, and a speaker operating module. On the other hand, if the portable electronic terminal is a compound terminal like a PDA phone, the modules are divided for example into a PDA operating module and a phone-operating module, or they can be subdivided as in the cellular phone. In addition, in terms of the functions each module performs, the modules can be divided into a continuously operating module, a cyclically operating module, and an operating module at an external request. The continuously operating module, like the radio transmission/receipt operating module, should be continuously supplied power. The cyclically operating module is set to operate on the regular basis, so its power supply is turned on/off cyclically. Lastly, the operating module at an external request is turned off in wait state, and if there is an external operation request, for example, user input, it is turned on for operation.

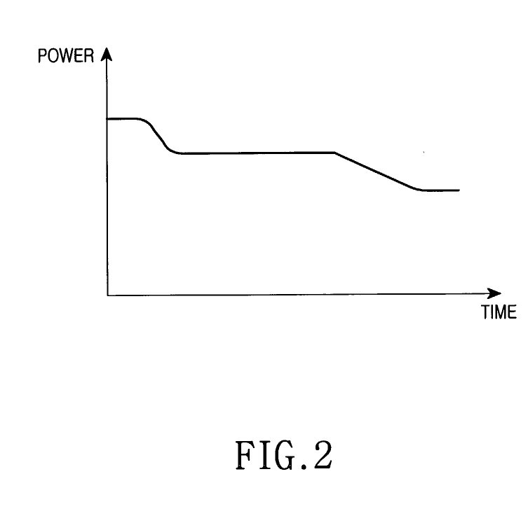

The memory 20 stores program data necessary for controlling the portable electronic terminal, and other data that is generated in the course of performing the operations. The memory 20 according to the present invention, as shown in FIG. 2, stores data based on a relation of consumption time to power maintenance, in conforming to a self-power consumption curve of the battery 40. FIG. 2 is a battery's self-power consumption curve in accordance with the preferred embodiment of the present invention. Base on the data, the controller 10 calculates voltage maintenance time for actually operating the modules.

In addition, the memory 20 stores data on power consumption of each module. Preferably, the memory 20 stores program data on a ‘power management menu’. This power management menu sets a power-saving mode. The power-saving mode decides priority for the plural modules 50, . . . , N in accordance with the degree of importance of each function performed by an individual module, and the operation time thereof. Therefore, when power is not sufficient for all of the modules, the modules with higher priorities get the power first. In order to decide priority of each module in accordance with various standards, and to suspend power, the power management menu of the present invention includes a ‘priority setting’ menu and ‘power-saving mode selection’ menu. The ‘priority setting’ menu for setting priority of each module is subdivided into an ‘automatic setting’ menu, and a ‘user setting’ menu. In conforming to a certain standard, the ‘power-saving mode selection’ menu decides which module should be provided with power. The ‘power-saving mode selection’ menu is subdivided to a ‘time priority’ and a ‘function priority’.

The ‘automatic setting’ menu the controller 10 sets a priority for each module according to a predetermined basic priority sequence. The ‘user setting’ menu sets priority for the modules according to the user's choice. The basic priority sequence is decided depending on the degree of importance of each function performed by an individual module. Since the ‘automatic setting’ menu decides priority based on a predetermined basis, modules are not given the same priority. However, since the ‘user setting’ menu decides priority in accordance with the user's choice, modules can have the same priority.

The ‘time priority’ menu decides power to be supplied to each module according to the predetermined priority given to each functional module of the portable electronic terminal, enabling an individual module to operate as long as possible. The ‘function priority’ menu designates power to be supplied to each module according to the predetermined priority given to each functional module of the portable electronic terminal, enabling as many modules as possible to operate.

The user selects the power management menu and its subdivided (or lower) menus among the menus included in the portable electronic terminal, the controller 10 designates power to be supplied to each module, assigns proper priority thereto, prepares a table regarding the priority, and stores the table in the memory. For example, suppose that a user selected the ‘automatic setting’ menu, and the ‘function priority’ menu. Then, the controller 10 decides priority in accordance with the basic priority of each module, and sets an appropriate power supply within the range of operation power to operate.

As an example, if the portable electronic terminal includes a phone operating module, a PDA operating module, and a digital camera operating module having the basic information shown in Table 1 below, and if the user selects the ‘automatic setting’ menu, and the ‘function priority’ menu, the controller 10 composes a table similar to Table 2 and stores the information in Table 2 in the memory 20.

TABLE 1

| | | Range of |
|---|---|---|
| | Basic priority rank | operating power |
| Phone operating module | 1 | 2.0 V˜2.4 V |
| PDA operating module | 2 | 0.3 V˜0.7 V |
| Digital camera operating | 3 | 0.5 V˜1 V |
| module | | |

TABLE 2

| | | Power supply |
|---|---|---|
| | Priority rank | (Function priority) |
| Phone operating module | 1 | 2.0 V |
| PDA operating module | 2 | 0.3 V |
| Digital camera operating | 3 | 0.5 V |
| module | | |

If the user selects the ‘user setting’ menu, the controller 10 provides a list of modules that the user can decide priority. When the user chooses an arbitrary module out of the modules in the list, selects a priority rank, and inputs the priority rank, the controller 10 sets the inputted priority rank to the corresponding module. At this time, the user can designate the same priority rank to a plurality of modules, and set a lend power option (lend Pwr) to each module with the same priority rank. The lend power option is an option for permitting, if necessary, the modules to temporarily turn off. If power is deficient, the module with the lend power option designated is temporarily turned off, and the power that used to be supplied to the module designated by the lend power option is provided to another module that needs to be operated at that moment.

Meanwhile, a module's own basic priority is given to other modules without any priority rank from the user. Therefore, although there might be modules with the same priority rank, a module having received priority earlier has a higher priority rank.

For example, in the portable electronic terminal having the structure shown in Table 1, suppose that the user selects the ‘user setting’ menu, and gives the highest priority rank to the PDA operating module, while giving the same priority rank to the phone operating module and the digital camera operating module, and sets the lend power option on the phone operating module, and selects the ‘time priority’ menu. In such case, the controller 10 composes a table similar to Table 3 below, and stores the information contained in Table 3 in the memory 20.

TABLE 3

| | | Power supply | |
|---|---|---|---|
| | Priority | (Time priority) | Lend Pwr |
| Phone operating | 2 | 2.4 V | Y |
| module | | | |
| PDA operating | 1 | 0.3 V | N |
| module | | | |
| Digital camera | 2 | 0.5 V | N |
| operating module | | | |

The following is an explanation of the operation of the controller 10 of the portable electronic terminal whose priority and detailed power-saving mode are set according to the above-described procedure. The controller 10, according to the predetermined cycle, compares the currently available power in the battery 40 to the sum of necessary power to operate each module. The necessary power to operate a certain module is referred to as the module on necessary power. A currently operating module having power supplied to it is referred to as a power on module, while a module whose power supply is suspended is called a power off module. If the power required by the module on necessary power is greater than the currently available power, the controller 10 discontinues supplying power to the module with the lowest priority among the modules to which power supply suspension is allowed and upgrades an off module list. Here, the off module list is a list of modules to which power supply is not allowed. Next, in the case of a cyclically-operating module, if the available power is not enough to operate the cyclically-operating module especially when the module needs to be operated, power supply is temporarily suspended to a module or modules with a lower priority rank, on which lend power option is set, among the modules having the same priority rank with the cyclically-operating module and power is used for operating the cyclically-operating module instead. When the cyclically operating module finishes its operation, the modules to which power supply was temporarily suspended are provided with power again. Lastly, in the case of an operating module at an external request, if the subject module is turned off, or power is not sufficient for operating the module, power supply to a module or modules with lower priority rank, on which lend power option is set, among the modules having the same priority rank with the operating module at an external request is temporarily suspended, and instead, power is used for operating the external request module. Similar to before, when the external request module finishes its operation, the modules to which power supply was temporarily suspended are provided with power again.

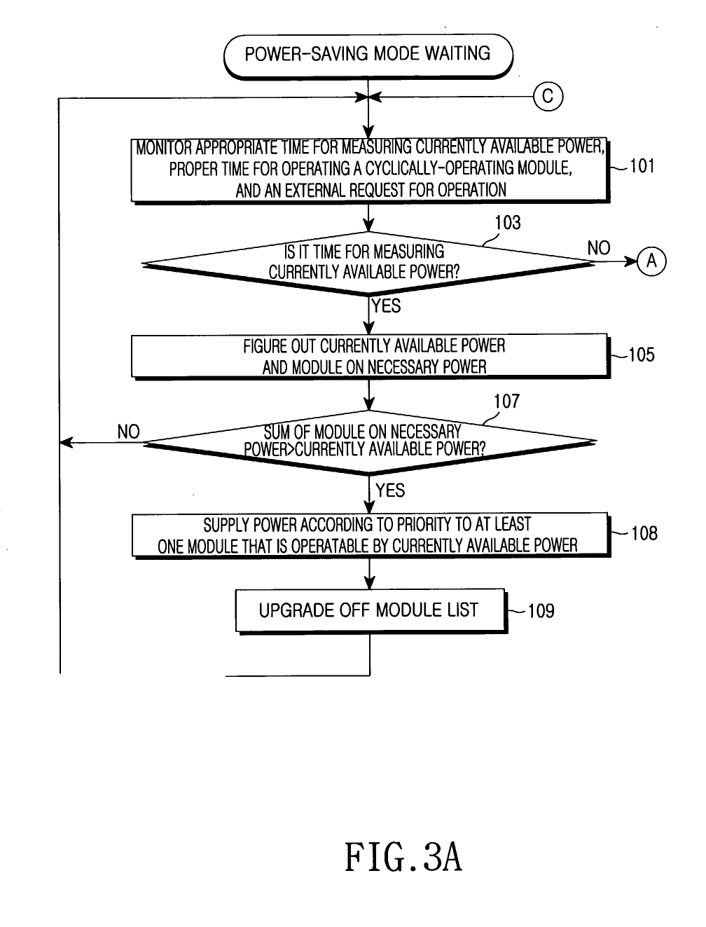

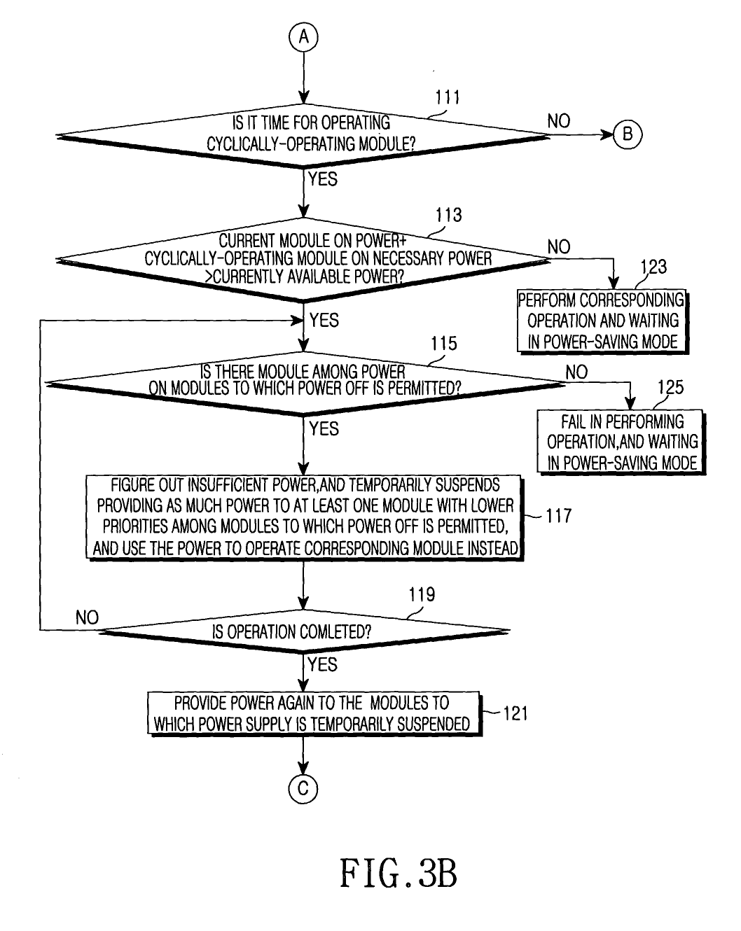

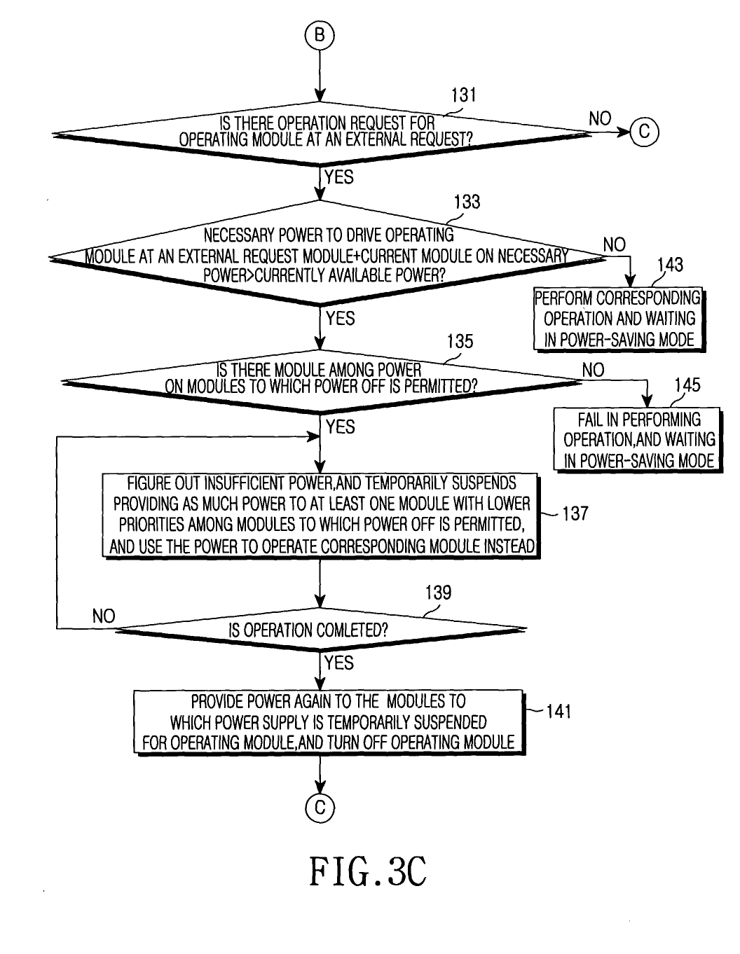

The operational flow charts of FIGS. 3a, 3b and 3c of the controller 10 under the power-saving mode will now be described. FIG. 3a is an operational flow chart of a controller 10 in the course of basic power saving procedure in accordance with the preferred embodiment of the present invention, FIG. 3b is an operational flow chart of the controller 10 describing a cyclic operational procedure of a module in accordance with the preferred embodiment of the present invention, and FIG. 3c is an operational flow chart of the controller 10 at an external request in accordance with the preferred embodiment of the present invention.

Referring to FIG. 3a, at step 101 the controller 10 monitors an appropriate time for measuring currently available power, a proper time for operating a cyclically operating module, and whether there is an external request for operation. The controller confirms at step 103 if it is the time for measuring currently available power, and if it is, step 105 proceeds, but if not, the step 113 illustrated in FIG. 3b proceeds. At step 105, the controller 10 determines the currently available power and the sum of the power of the modules on necessary power, and step 107 proceeds. At step 107, if it is determined that the sum of the power of the modules on necessary power is greater than the currently available power, step 108 proceeds. However, if the sum of the power of the modules on necessary power is less than the currently available power, the controller 10 goes back to step 101. At step 108, in accordance with priority, the controller 10 supplies power to at least one module that is operatable by the currently available power. If more power is available then required by one module, other modules, according to priority, are supplied power. That is, it suspends power supply to modules with lower priorities. Afterwards, at step 109, the controller 10 upgrades the off module list, and step 101 proceeds.

On the other hand, at step 111 of FIG. 3b, if the controller 10 determines that it is time to operate the cyclically operating module, step 113 proceeds. However, if it is not the operating time, step 131 of FIG. 3c proceeds. At step 113, the controller compares the sum of the necessary power to operate the cyclically-operating module and the current module on necessary power to the currently available power, and if it is determined that the sum of the current module on necessary power and the necessary power to operate the cyclically-operating module is greater than the currently available power, step 115 proceeds. On the other case, i.e., if the sum of the current module on necessary power and the necessary power to operate the cyclically-operating module is less than the currently available power, step 123 proceeds. At step 123, the controller 10 performs the relevant operation, and returns to the waiting state of power-saving mode. At step 115, the controller 10 determines whether there is any modules among power on modules, to which power off is allowed, and if there is such a module, step 117 proceeds, but if there is no module with power off permission, step 125 proceeds. Here, the modules with power off permission indicate any module whose priority rank is lower than the cyclically-operating module, or a module on which the lend power option is set among the modules having the same priority rank with the cyclically-operating module. At step 125, the controller 10 fails in performing a concerned operation, and remains at the waiting state in power-saving mode. At step 117, the controller 10 determines that there is insufficient power, and temporarily suspends providing as much power to at least one module with lower priorities among the modules to which power off is permitted, and uses the power to operate a corresponding module instead. Afterwards, at step 119, if the cyclically operating module finished its operation, step 121 proceeds, but if not, step 115 proceeds. At step 121, the controller 10 provides power again to the modules to which power supply was temporarily suspended for operating a concerned module, and step 101 in FIG. 3a proceeds.

If at step 111, it is determined that it is not time for operating cyclically operating modules, the procedure goes to step 131 of FIG. 3c. At step 131, the controller 10 determines if there is a request for operating the operating module at an external request, and if it is determined that there is the request, step 133 proceeds, but if there is no request for operation, step 135 proceeds. At step 133, the controller 10 compares the sum of necessary power to operate the operating module at an external request module and the current module on necessary power to the currently available power, and if it turns out that the sum of necessary power to operate the operating module at an external request module and the current module on necessary power is greater than the currently available power, step 135 proceeds. On the other case, i.e., if the sum of necessary power to operate the operating module at an external request module and the current module on necessary power is less than the currently available power, step 143 proceeds. At step 143, the controller 10 performs the relevant operation, and goes back to the waiting state in power-saving mode. At step 135, the controller 10 determines whether there is any module among power on modules, to which power off is allowed, and if there is such module, step 137 proceeds, but if there is no module with power off permission, step 145 proceeds. At step 145, the controller 10 fails in performing the concerned operation, and remains at the waiting state in power-saving mode. At step 137, the controller 10 determines that there is insufficient power, and temporarily suspends providing as much power to at least one module with lower priorities among the modules to which power off is permitted, and uses the power to operate a corresponding module instead. Afterwards, at step 139, if the cyclically operating module finished its operation, step 141 proceeds, but if not, step 137 proceeds. At step 141, the controller 10 provides power again to the modules to which power supply was temporarily suspended for operating a concerned module, and step 101 in FIG. 3a proceeds.

As an example, the following describes the operational procedure of the controller 10 of the portable electronic terminal with a built-in memory where the information of Table 3 aforementioned is stored. First of all, the controller 10 determines the sum of the power required for the modules on necessary power, i.e., necessary power for the phone operating module and the PDA operating module, and compares the sum to the currently available power. At this time, the digital camera-operating module, which is an operating module at an external request, is turned off in waiting state. As a result of the comparison, if it turns out that the sum is greater than the currently available power (given that the currently available power is less than 2.7V), the controller 10 turns the phone-operating module off. However, if the currently available power is above 2.7V, the phone operating module and the PDA operating module remain being turned on. At this point, if a user inputs a request for operating the digital camera-operating module, the controller 10, given that the currently available power exceeds 3.2V, operates the digital camera-operating module, but if the currently available power is below 3.2V, the controller 10 searches a module to which power off is allowed. In Table 3, for example, the priority rank of the phone operating module is 2, which is the same priority rank with the digital camera operating module, and the lend power option is set on the phone operating module. In such case, it is possible to suspend power supply to the phone-operating module. Thus, the controller 10 temporarily suspends power supply to the phone-operating module, and operates the digital camera-operating module instead. When the operation of the digital camera-operating module is completed, the controller 10 provides power back to the phone-operating module.

In conclusion, the present invention decides priority in accordance with the user's intention, or on the degree of importance of each functional module, or on the operation time thereof. Therefore, when power is deficient, the modules with lower priorities are temporarily not provided with power which means that the modules with higher priorities are guaranteed for continuous operation. In this manner, the present invention can manage power of a portable electronic terminal much more effectively.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A power management method for a portable electronic terminal having at least two modules that perform distinct functions of the terminal, the method comprising the steps of:
setting a priority for each module;
calculating a sum of necessary power to turn on the at least two modules under power-saving mode, and measuring a currently available power at intervals of a predetermined cycle;
comparing the sum of necessary power to turn on the modules with the currently available power; and
if the currently available power is less than the sum of necessary power to turn on all of the modules, allotting the currently available power to at least one module based on the set priority.

2. The method defined in claim 1, wherein the portable electronic terminal stores data on self-power consumption curve of a battery for supplying power to the terminal, and stores data on consumption power of each module.

3. The method defined in claim 1, further comprising the steps of:
monitoring an operation time of a cyclically-operating module which operates per designated cycle under the power-saving mode;
if a present time is the operation time of the cyclically-operating module, deciding whether available power is insufficient to operate the cyclically-operating module;
if power is insufficient to operate the cyclically-operating module, confirming whether a power off is allowed to a certain module among modules receiving power;
if the power off is allowed to a certain module, determining the amount of insufficient power to operate the cyclically-operated module, and temporarily suspending power supply, as much power as the insufficient amount, to a module with the lowest priority and then in ascending order among modules to which the power off is allowed, and operating the cyclically-operating module; and
if the cyclically-operating module completes the operation thereof, restoring the power to the modules to which the power supply has been temporarily suspended.

4. The method defined in claim 1, further comprising the steps of:
if an operating module at an external request needs to be operated upon the external request under the power-saving mode, deciding whether available power is insufficient to operate the operating module at an external request;
if power is insufficient to operate the operating module at an external request, confirming whether power off is allowed to a certain module among modules receiving power;
if the power off is allowed to a certain module, determining the amount of insufficient power to operate the module at an external request, and temporarily suspending power supply, as much power as the insufficient amount, to a module with the lowest priority and then in ascending order among modules to which the power off is allowed, and operating the operating module at an external request; and
if the operating module at an external request completes operation thereof, restoring power to the modules to which the power supply has been temporarily suspended, and turning off the operating module at an external request.

5. The method defined in claim 1, wherein the priority rank is determined according to one of specific priority ranks assigned to the at least two modules, and a priority rank that is arbitrarily decided according to the user's choice.

6. The method defined in claim 3, wherein the module to which power off is allowed is one of the cyclically-operating modules, and one of modules having the same priority rank to which a lend power option is designated.

7. The method defined in claim 6, wherein the power supply is temporarily suspended for providing necessary power to operate a module with the same priority rank.

8. The method defined in claim 4, wherein the module to which power off is allowed is one of the modules having a lower priority rank than the operating module at an external request and one of modules having the same priority rank to which a lend power option is designated

9. The method defined in claim 8, wherein the power supply is temporarily suspended for providing necessary power to operate a module with the same priority rank.
